(19) United States
(12) Patent Application Publication
(10) Pub. No.: US 2024/0288317 A1
(43) Pub. Date: Aug. 29, 2024

(54) MEASUREMENT SET-UP AND MOUNTING

(71) Applicant: TDK Electronics AG, München (DE)

(72) Inventors: Markus WEHRING, Potsdam (DE); Daniel GILLE, Berlin (DE); Carsten DEHOFF, BERLIN (DE)

(73) Assignee: TDK Electronics AG, München (DE)

(21) Appl. No.: 18/572,331

(22) PCT Filed: May 30, 2022
(86) PCT No.: PCT/EP2022/064596

§ 371 Date: Dec. 20, 2023

(30) Foreign Application Priority Data
Jun. 22, 2021 (DE) 102021116111.8

(51) Int. Cl. G01K 1/16; G01K 1/14

(52) U.S. Cl. CPC G01K 1/16; G01K 1/14

(57) ABSTRACT

A measuring assembly for measuring a temperature of a test body is provided, wherein at least two separate wires suitable for thermal conduction are led away from a test body and combined into a wire bundle at a distance from the test body, and wherein a temperature sensor is attached to the wire bundle by clamping action by means of a holder. Preferably, the holder comprises a holder base having an inner side and an outer side, and spring clips connected thereto, wherein a recess for receiving a temperature sensor is arranged on the inner side of the holder base, and wherein two of the spring clips are arranged opposite each other with respect to the holder base and are adapted to generate a clamping force towards the inner side of the holder base.

### CROSS-REFERENCE TO RELATED APPLICATIONS

The present application is the national stage entry of International Patent Application No. PCT/EP2022/064596, filed on May 30, 2022, and published as WO 2022/268442 A1 on Dec. 29, 2022, which claims the benefit of priority of German Patent Application No. 10 2021 116 111.8, filed on Jun. 22, 2021, the disclosures of all of which are incorporated by reference herein in their entireties.

### FIELD OF THE INVENTION

The present application is directed to a measuring assembly for measuring a temperature and a holder.

### BACKGROUND OF THE INVENTION

Temperature detection or temperature measurement is relevant in various technical systems. This also applies in particular to electric motors, for example for electric mobility applications.

Concepts for temperature measurement are known, for example, from WO 00/2019115224 A1 or Ser. No. 10/436,648 B2.

One task of the present invention is to provide a method for temperature measurement that improves upon the concepts shown above. Further tasks are solved by advantageous embodiments of the invention.

### SUMMARY OF THE INVENTION

According to a first embodiment, a measuring assembly for measuring a temperature of a test body is provided, wherein at least two separate wires suitable for thermal conduction are led away from a test body and are combined into a wire bundle at a distance from the test body. In addition, a temperature sensor is attached to the wire bundle by means of a holder that exerts a clamping effect.

In a measuring assembly according to the first embodiment, wires suitable for thermal conduction are preferred, i.e., such wires with good thermal conductivity. For example, the thermal conduction of metals can be considered as good thermal conduction.

According to an embodiment, the wires have metallic components or consist of metals. For example, the wires may have a core that comprises metallic components and is covered with insulation. The cover may be thermal insulation or electrical insulation. Preferred metallic constituents include copper, silver, aluminum, or gold. Alternatively, alloys having a high proportion of these metals are preferred, with a high proportion corresponding to a proportion of these metals of at least 50%. Even more preferably, a core or the entire wire is made of one of the above metals. For example, the wires may be copper wires.

The wires are routed away from the test body and are combined into a wire bundle at a distance from the test body. Thus, the temperature measurement takes place at the wire bundle and not directly at the test body. This can enable temperature measurement of areas of the test body that are inaccessible for direct attachment of a sensor. It is sufficient if wires can be attached to the test body.

Distance from the test body can be understood to mean that at least one of the wires is not directly combined at its starting point on the test body with another wire or several wires to form the wire bundle. Please note that it is irrelevant here whether the wires are already bundled directly at the test body or not. The wire bundle can preferably be understood as a bundled area of the wires where the temperature measurement is performed, i.e. where the holder and the temperature sensor are located.

According to an embodiment, the distance between the origin of the wires and the wire bundle measured along the course of the wires is 1 to 100 cm.

The wire bundle can be described as the measuring body on which the actual temperature measurement is carried out, i.e. on which the temperature sensor is located. In contrast, the test body is the body whose temperature is to be measured with the measuring assembly.

At a distance from the test body, the at least two wires are bundled to form the wire bundle. Preferably, the wires in the area of the wire bundle are largely parallel and in direct contact with each other. Outside the wire bundle, the wires can be unbundled.

Within the wire bundle, the wires are preferably at least partially stripped of insulation if they otherwise have insulation. This has the advantage that a temperature measurement can be made directly at the heat-conducting metallic components.

The temperature sensor used here can basically be any temperature sensor. In particular, the temperature sensor is preferably suitable for precisely detecting the temperature in a temperature range between-55° C. and 300° C. or even more preferably in a temperature range between −40° C. and 200° C. In particular, an NTC sensor is preferred as a temperature sensor.

The temperature sensor is attached to the wire bundle by means of a clamping effect. Preferably, the temperature sensor is clamped to the wire bundle. For this purpose, the holder is preferably clamped around the bundle. Accordingly, the temperature sensor is not sandwiched between the at least two separate wires. Any suitable holding device may serve as the holder. A clamping holder or clamp is preferred. Even more preferably, the holder or clamp described below can be used.

Furthermore, the holder or clamp can also be suitable for holding the wires together as a wire bundle. However, this is not necessary and can be achieved by other measures.

According to an embodiment, the measuring assembly is designed such that all wires are attached at different points on the test body.

In other words, all the wires can originate from different points on the test body. This has the particular advantage that an averaged temperature of the at least two different points can be measured by the temperature sensor.

If more than two separate wires are used, the averaging of the test body temperature can become even more precise or accurate.

In particular, in the combination of the first embodiment and the previous embodiment, an even better inventive advantage can be achieved, since an averaged temperature of many measuring points of the test body can be detected without the need for several temperature sensors, which are voluminous compared to wires, to be directly attached to the test body.

According to another embodiment, the wires are combined in the region of the wire bundle by a bundling means.

Furthermore, according to this embodiment, the temperature sensor is clamped or pressed to the bundling means by the holder.

Furthermore, it is preferred that the bundling means is a separate part from the holder.

Consequently, the temperature according to this embodiment is preferably measured at the bundling means. Thus, the bundling means can be referred to here as a measuring body according to the definition given above. For temperature measurement, the bundling means preferably has a surface against which the temperature sensor with the holder can be pressed.

The bundling means preferably has good thermal conductivity.

Furthermore, the bundling means is preferably mechanically stable. Preferably, the bundling means is a metallic bundling means. Many metals have both high thermal conductivity and sufficient mechanical stability. For example, the bundling means contains iron, steel, stainless steel, copper, aluminum, or alloys containing these materials. It may be composed of these materials. Of these materials, steel or stainless steel is particularly preferred because it is especially mechanically stable in comparison to other materials and has sufficiently good thermal conductivity. In some embodiments, bundling means may also be coated

For example, the wires can be at least partially stripped of insulation in the area of the bundling means, if they otherwise have insulation in addition to the heat-conducting material.

For example, the bundling means may be a crimp.

Furthermore, the bundling means is even more preferably a hot crimp.

A hot crimp has the advantage that possible insulation can be stripped automatically due to the temperature during the process of attaching the crimp, i.e. during crimping.

Furthermore, the hot crimp can preferably have an oval shape with a smooth surface. The smooth surface is particularly well suited for the temperature sensor to be clamped to it. A suitable holder, for example as described below, can be attached particularly efficiently to an oval shape.

According to a further embodiment, the wires may be electrical wires. Preferably, they can be supply lines of electric current to the test body or serve as such.

In this context, the term “supply line” includes all wires that are current-carrying or can conduct a current. The supply lines can also be connected to ground, for example.

According to another embodiment of the measurement setup, the test body may be an electric motor.

An electric motor is particularly suitable for the above-mentioned measuring method or measuring assembly, since common motors often have many points that are inaccessible for temperature measurement.

Furthermore, for modern electric motors, for example in the field of electric mobility, accurate and averaged temperature measurement is of great importance.

In accordance with another embodiment of the invention, a holder is described.

In this context, the invention is primarily directed to a holder, yet which is also described in connection with a temperature sensor which can be accommodated in this holder and with a measuring body to which? it can be attached. The holder is to be considered here independently of these other components according to the invention. However, the invention also includes any described arrangement in which the holder together with a measuring body and/or a sensor are installed together. Further, the invention also includes an ensemble of these components, wherein in an ensemble the components may be present side by side without being installed together.

The holder, which is described below, is particularly suitable for a measuring assembly according to the previous description.

Accordingly, a holder is described which has a holder base with an inner and an outer side and spring clips connected thereto. Here, a recess for receiving a temperature sensor is arranged on the inner side of the holder base. In addition, two of the spring clips are arranged opposite each other with respect to the holder base. These are suitable for generating a clamping force in the direction of the inner side of the holder base.

The inner side is preferably the side facing a measuring body in a measuring assembly or measuring arrangement. The outer side is thus preferably the side facing away from this measuring body.

The recess is arranged in the holder base on its inner side so that a sensor to be inserted into the holder can come to rest directly on a measuring body, for example a hot crimp, resting on the inner side, without parts of the holder being arranged between the sensor and the measuring body.

Preferably, the temperature sensor comes to rest with a contact surface on the measuring body. The contact surface is particularly suitable for establishing a thermally conductive contact. Preferably, the contact surface faces away from the inner side of the holder base.

Thus, good thermal conduction can be provided between the measuring body and the sensor, and a complex shape of a sensor can be avoided. In particular, it can avoid the need to form areas protruding from a sensor main body that must make thermal contact with the measuring body through the holder or past components of the holder.

The two spring clips, which are opposite each other in relation to the holder base, form a pair. Due to their appropriate arrangement, they can grip a measuring body, for example a hot crimp, from two opposite sides, i.e. mutually. Thus, the force application can be symmetrical from both sides. This also allows a portion of the clamping force to act in the direction of the inner side of the holder base. In this way, a temperature sensor to be inserted into the recess can be pressed against a measuring body.

By clamping force in the direction of the inner side of the holder base, the sensor can be pressed into the recess without the need for further brackets, fasteners or clamping of the temperature sensor in the holder.

In addition, a portion of the clamping force can also act from one of the spring clips in the direction of the other spring clip and consequently the measuring body can then be clamped between the two clips.

According to an embodiment of the holder, the recess includes a stop that can inhibit movement of a temperature sensor to be inserted into the recess out of the recess.

In this case, it is preferred that a temperature sensor to be inserted is in contact with the stop.

The direction from the center of the recess perpendicular to the stop can be described as the insertion direction of a temperature sensor to be inserted. The temperature sensor to be inserted is therefore preferably inserted in the insertion direction.

It is preferred that the stop inhibits movement of the temperature sensor out of the recess in the insertion direction.

It is further preferred that a sensor to be inserted is bounded on further sides, for example by the spring clips or by side walls of the holder base from which the spring clips extend as explained above.

According to another embodiment, the holder comprises a clamping tab provided and adapted to fix a temperature sensor to be inserted in the recess.

This allows the temperature sensor to be held or fixed in the recess without the holder with sensor having to be pressed against a measuring body.

It is preferred that the clamping tab extends from an interior portion of the holder base.

It is preferred that the clamping tab extends along one side of the recess. Preferably, the clamping tab extends from an inner side of the holder base along a direction which is defined parallel to the direction from the outer side to the inner side. Preferably, the clamping tab is not arranged on the side on which the stop is arranged. Even more preferably, the clamping tab is arranged parallel to the insertion direction and the clamping effect of the clamping tab acts perpendicular to the insertion direction. Preferably, the clamping tab clamps a sensor to be inserted into the recess against a side wall of the recess opposite the clamping tab.

A force component can also act in the direction of the inner side of the sensor base. However, it is important here that the clamping tab does not extend onto the contact surface of the sensor. For example, in the case of a partially round or partially oval shape of the sensor, the clamping tab can partially enclose the sensor without extending onto the contact surface. Consequently, in generalized terms, the clamping tab preferably has an at least partially matching shape to the sensor to be inserted into the recess. This allows them to enclose it in an at least partially form-fitting manner.

Alternatively or additionally, the clamping tab can engage with an engagement area in a matching recess or indentation in the sensor to improve the fixation of the sensor.

Furthermore, a second clamping tab can additionally be arranged on the opposite side of the recess to the clamping tab described above. This pair of clamping tabs formed in this way can provide a symmetrical clamping force load on the sensor. In this way, an even more stable fixation can be achieved.

Preferably, the holder can be manufactured in one piece. This has the advantage that weak points at joints of assembled components can be avoided.

Thus, the holder can be made of the same material in all its areas.

This, in particular, together with the previously mentioned embodiment, has the advantage that the holder is formed from the same flexible material, which allows the necessary flexibility and clamping force to be provided for both the spring clips and the clamping tab or tabs.

According to a further embodiment, the holder can be manufactured as a stamped and bent part. This has the advantage of enabling a particularly easy manufacturing. Thus, such a holder is preferably made of sheet metal. The sheet metal may preferably comprise steel, stainless steel, copper or aluminum. It may also consist of these materials or of alloys comprising these materials. The sheet metal may be coated.

Alternatively, the holder can be made of plastic or be made of plastic. In this way, the holder can be particularly light. This can help to ensure that the course of the wires of a wire bundle is not impaired by the weight of the holder.

A suitable plastic can be selected from polyamides, such as polyamide 66, polypropylene, polyphthalamides, polyphenylene sulfide or polyurethanes. Generally, the applicability of plastic holders depends on the application temperatures. The choice of plastic can also be adapted to the application temperature.

According to another embodiment, the recess includes an opening that allows electrical cables to be routed through the opening.

According to an embodiment, these electrical cables are electrical supply or discharge cables of a temperature sensor to be inserted into the recess.

According to an embodiment, the opening can be arranged on the side opposite the stop. Here, the direction from the opening to the stop side can preferably correspond to the insertion direction. In the near vicinity of the holder, the electrical cables can also run approximately in the insertion direction. Preferably, the insertion direction and thus the local guiding direction of the cables is oriented perpendicular to wires in the wire bundle. This allows the sensor cables to be routed away from the wire bundle as efficiently as possible. This avoids sharp bending of the cable to guide it away.

According to a further embodiment, the recess is shaped such that a temperature sensor can be inserted into the recess in an at least partially form-fitting manner.

In an at least partially form-fitting manner can mean here that, for example, one side, which is not the side that comes into contact with a measuring body, fits into the accordingly shaped recess. In this case, the recess does not have to reproduce every shape feature of the temperature sensor or of one side of the temperature sensor. In this case, in a form-fitting manner means that the shape of the temperature sensor is mimicked like a negative to a positive at least to the extent that wobbling of the temperature sensor in the recess is minimized.

According to a further embodiment, the holder comprises two further spring clips arranged opposite each other with respect to the holder base and adapted to generate a clamping force towards the inner side of the holder base.

According to this embodiment, the holder comprises four spring clips. These four spring clips each form pairs of two opposing spring clips, each of which can be understood as a pair of spring clips.

The second pair of spring clips may have similar characteristics to the first.

Together, the total of four spring clips are preferably arranged symmetrically with respect to the holder base. This can provide a stable four-point fixation or four-point clamping of a temperature sensor to a measuring body.

According to a further embodiment of the holder, the spring clips are adapted to at least partially embrace an oval-shaped measuring body to provide a clamping effect and to effect attachment to the measuring body, wherein the spring clips bear against the measuring body in a substantially form-fitting manner but in an undersized manner.

Many possible measuring bodies on which temperature is to be measured have a more or less oval shape. In particular, common hot crimps have an oval shape.

In this case, form-fitting means, in particular with regard to the oval shape, that part of the spring clips at least partially replicates the shape. In this case, the shape is undersized, i.e. in the unclamped state it can be smaller than the measuring element shape or, for example, imitate the oval shape with an opening angle or radius that is too small. By clamping, the undersized shape is expanded, whereby the clamping effect can be created as a counterforce to the expansion.

According to a further embodiment, the material of the spring clips is selected to be spring-elastic at a temperature load of 100° C. to 200° C.

The above-mentioned materials are particularly suitable for this purpose.

This property makes the holder particularly suitable for use on electric motors in electric vehicles, as they are thus spring-elastic in the temperature range prevailing there.

Even more preferably, spring clips are spring-elastic even under engine starting conditions, i.e. a temperature range of −20 to 50° C.

Similar requirements are preferably met by the clamping tabs.

### BRIEF DESCRIPTION OF THE DRAWINGS

The invention is described in more detail below with reference to exemplary embodiments. These exemplary embodiments are shown in the following figures, which are not to scale. Lengths as well as relative and absolute dimensions can thus not be taken from the figures. Furthermore, the invention is also not limited to the following embodiments.

FIG. 1 shows a perspective view of an exemplary embodiment of a holder.

FIG. 2 shows a view of the inner side of the exemplary embodiment of the holder.

FIG. 3 shows a side view of the exemplary embodiment of the holder.

FIG. 4 shows another side view of the exemplary embodiment of the holder.

FIG. 5 shows a perspective view of an exemplary embodiment of a measuring arrangement.

FIG. 6 shows a schematic sketch of an exemplary embodiment of a measurement setup.

### DETAILED DESCRIPTION

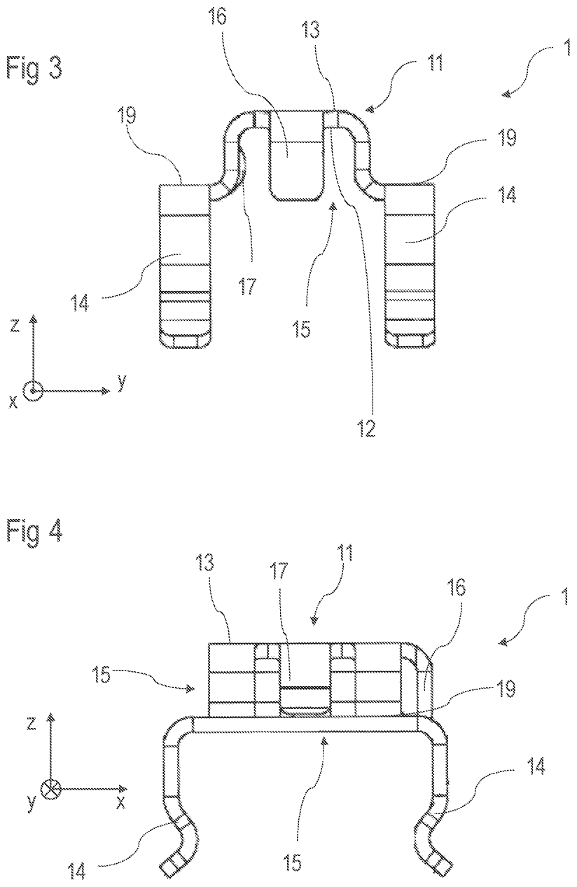

In FIGS. 1 to 4, a first exemplary embodiment of a holder 1 according to the present invention is shown in different views. A coordinate system x, y, z is shown for the holder 1 in each case, which can be regarded as an internal coordinate system of the holder 1.

As can be seen in all of FIGS. 1 through 4, the holder 1 includes a holder base 11. Further components including the spring clips 14 extend from the holder base 11.

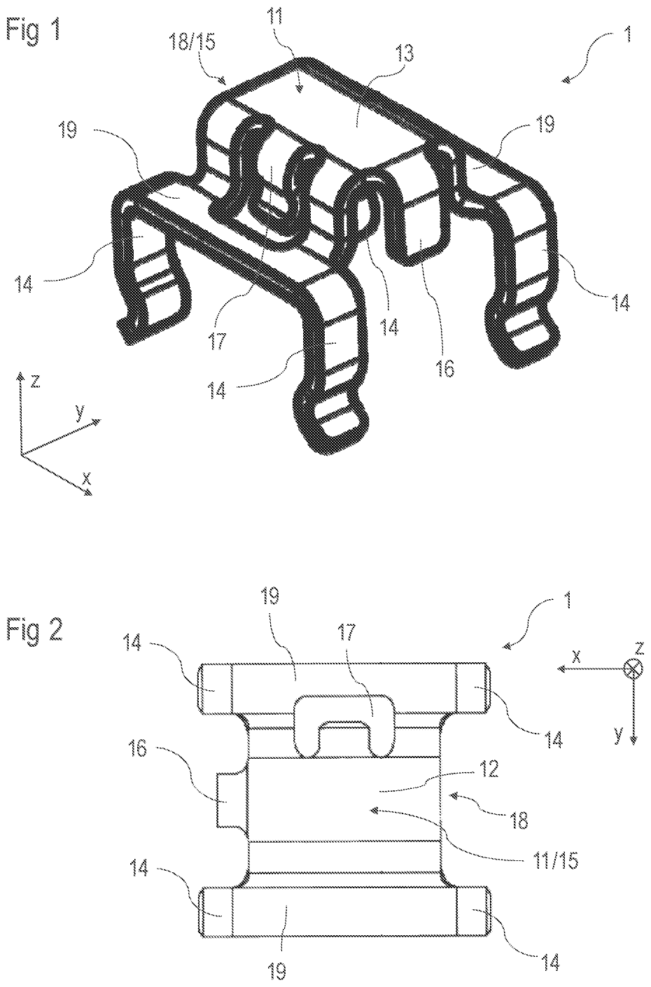

In particular, the holder base 11 has an inner side 12 and an outer side 13. The inner side 12 is particularly apparent in the view of FIG. 2.

The direction from inner side 12 to outer side 13 corresponds to the z-direction of the coordinate system shown next to holder 1.

Furthermore, the holder base has a recess 15. The recess 15 is suitable for a temperature sensor to be inserted in an at least partially form-fitting manner.

The recess 15 has a stop 16. Opposite the stop 16 an opening 18 is arranged on the recess 15. The direction from opening 18 to stop 16 corresponds to the x-direction of the coordinate system.

Furthermore, the recess 15 has further side walls which are oriented along the x-direction. These limit the recess 15 perpendicular to the y-direction.

A clamping tab 17 is formed in one of the side walls. The clamping tab 17 is configured to fix a temperature sensor to be inserted by pressing it either by a clamping effect against the opposite side wall of the recess 15 or against the inner side 12. Preferably, the temperature sensor is pressed against the recess 15 in both of these directions. The clamping tab 17 is preferably machined out of a side wall during manufacture.

The x-direction corresponds to the insertion direction of a temperature sensor to be inserted into the holder 1, whereby the stop 16 prevents movement or sliding out of the recess 15 of the holder 1 in the insertion direction. For this purpose, a surface portion of the stop 16 is preferably oriented perpendicular to the insertion direction of a temperature sensor (here, the x-direction). In other words, a surface normal of a planar section of the stop 16 is oriented opposite to the x-direction.

A total of four spring clips 14 extend from the holder base 15, whereby these extend in such a way that bars 19 are attached to the side walls of the recess 15, on which the spring clips 14 are arranged perpendicular to the course of the bar. In this way, the spring clips 14, which are arranged at two ends of a bar 19 and are opposite each other in the x-direction, can be defined as a pair of spring clips.

Alternatively, only two spring clips (not shown) could face each other in the x-direction, preferably by filling the free space between the spring clips 14 adjacent in the y-direction with a material connecting the spring clips.

The clamping effect of the spring clips 14 is preferably oriented perpendicular to the clamping effect of the clamping tab 17. In particular, the insertion direction (x-direction) is parallel to the clamping effect of the spring clips 14. This enables a temperature sensor to be inserted perpendicular to the course of a measuring body.

By the spring clips 14 each extending from a bar 19 and the clamping effect being oriented parallel to the insertion direction, the tension or force generated by the spring clips or acting on the spring clips in a measuring assembly is not transmitted to the holder base. This prevents the holder base from being bent up under load parallel to the y-direction.

The holder shown in FIGS. 1 to 4 can be manufactured as a stamped and bent part or made of a plastic. In this way, the holder is preferably manufactured in one piece.

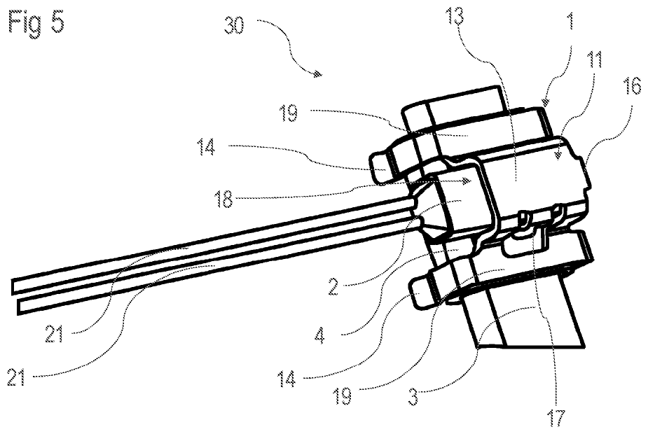

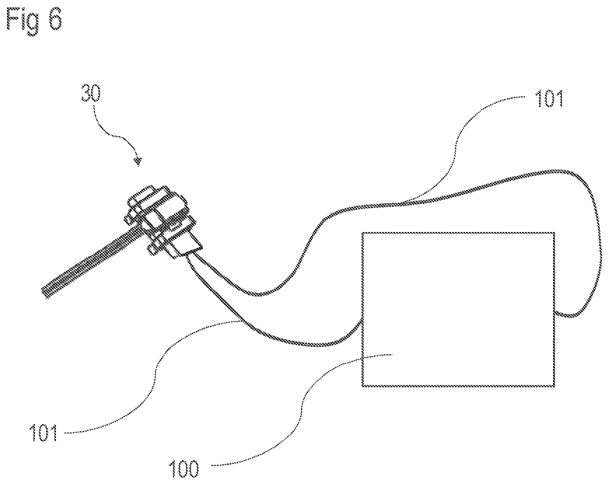

FIG. 5 shows a measuring arrangement 30. This measuring arrangement 30 can, for example, be part of the measuring setup as shown in FIG. 6.

The measuring assembly shown in FIG. 6 shows a schematically represented test body 100 from which wires 101 extend. The test body 100 may represent an electric motor, for example. The wires 101 start from different points of the test body 100 and are suitable to conduct heat from the test body to the measuring arrangement 30 in order to enable a temperature measurement within the measuring arrangement 30.

The measuring arrangement 30 in FIG. 5 comprises a wire bundle 3 in which at least two independent wires 101, as shown schematically in FIG. 6, are guided (wires not explicitly shown in FIG. 5). A hot crimp 4 is attached to the wire bundle 3 or as part of the wire bundle 3 as bundling means. The hot crimp 4 can at least partially strip the wires in the wire bundle so that there is good heat conduction contact between the wires and the hot crimp. The hot crimp 4 is also preferably made of metal, which also has good thermal conductivity.

A temperature sensor 2 is clamped to the hot crimp 4 by means of the holder 1 shown in the previous figures. Thus the wire bundle together with the hot crimp is the measuring body here. Here, one side of the temperature sensor 2, which has a temperature-sensitive element, or which is thermally conductively connected to a temperature-sensitive element, rests on a surface of the hot crimp 4.

The holder 1 shown is particularly suitable for a measuring assembly because it can bring the temperature sensor 2 into direct contact with the hot crimp 4 without parts of the holder 1 existing between a contact surface of the temperature sensor 2 and a corresponding contact surface on the hot crimp 4.

Cables 21 are led away from the temperature sensor 2 in a direction which is largely perpendicular to the direction of guidance of the wires in the wire bundle 3.

The wires which are bundled in the wire bundle 3 are connected to a test body, for example an electric motor. Via the wires, which for example have a metallic core that is at least partially exposed by the hot crimp 4, the heat is conducted from a test body to the measuring body (hot crimp 4) at which the temperature measurement takes place.

As can be seen, the recess 15 of the holder base 11 is formed in a form-fitting manner or in a substantially form-fitting manner to the temperature sensor 2, which can prevent wobbling.

Furthermore, the stop 16 prevents the temperature sensor 2 from slipping out in the insertion direction.

Furthermore, the temperature sensor 2 is fixed in the recess 15 by the clamping tab 17, wherein the clamping tab 17 causes at least one contact pressure against a side surface of the temperature sensor 2, wherein the temperature sensor 2 is pressed against the side of the recess 15 opposite the clamping tab 17 or against the inner side 12. Alternatively, another clamping tab 17 can be formed on the opposite side (not shown).

The spring clips 14 are at least partially adapted in a form-fitting manner to the oval shape of the hot crimp 4. In this case, the spring clips 14 are undersized, i.e. their opening angle or radius in the non-tensioned state is smaller than the rounding of the sides of the hot crimp 4, for example. Clamping creates a tension which generates the clamping effect of the holder.

The clamping effect causes the temperature sensor to be pressed against the hot crimp.

1. A measuring assembly for measuring a temperature of a test body, wherein
at least two wires which are separated from one another and which are suitable for thermal conduction are led away from a test body and which are combined at a distance from the test body to form a wire bundle, and
a temperature sensor being fastened by means of a holder to the wire bundle by a clamping effect.

2. The measuring assembly according to claim 1, wherein all wires are fixed to the test body at different points.

3. The measuring assembly according to claim 1, wherein the wires are combined in the region of the wire bundle by a bundling means and the temperature sensor is pressed against the bundling means by the holder.

4. The measuring assembly according to claim 3, wherein the bundling means is a hot crimp.

5. The measuring assembly according to claim 1, wherein the wires serve as supply lines of electric current to the test body.

6. The measuring assembly according to claim 1, wherein the test body is an electric motor.

7. A holder comprising a holder base having an inner side and an outer side and spring clips connected thereto, wherein a recess for receiving a temperature sensor is arranged on the inner side of the holder base, and wherein two of the spring clips are arranged opposite each other with respect to the holder base and are configured to generate a clamping force towards the inner side of the holder base.

8. The holder according to claim 7, wherein the recess comprises a stop for inhibiting a movement of a temperature sensor to be inserted into the recess out of the recess.

9. The holder according to claim 7, wherein a clamping tab is provided and suitable for fixing a temperature sensor to be inserted in the recess.

10. The holder according to claim 8, wherein the recess comprises an opening that allows electrical cables to be guided into the recess.

11. The holder according to claim 7, wherein the recess is shaped in such a way that a temperature sensor to be inserted can be inserted in an at least partially form-fitting manner into the recess.

12. The holder according to claim 7, wherein two additional spring clips are arranged opposite each other with respect to the holder base and are adapted to generate a clamping force towards the inner side of the holder base.

13. The holder according to claim 7, wherein the spring clips are adapted to at least partially embrace an oval-shaped measuring body to produce a clamping effect and thus effect attachment to the measuring body, wherein the spring clips bear against the measuring body substantially in a form-fitting manner but in an undersized manner.

14. The holder according to claim 7, wherein the material of the spring clips is spring-elastic at a temperature load of 100° C. to 200° C.
